(19) United States
(12) Patent Application Publication
(10) Pub. No.: US 2025/0375937 A1
(43) Pub. Date: Dec. 11, 2025

(54) METHOD OF FORMING A POLYMER COMPOSITE AND APPARATUS FOR THE SAME

(71) Applicants: Xiangjia Li, Chandler, AZ (US); Tengteng Tang, Tempe, AZ (US)

(72) Inventors: Xiangjia Li, Chandler, AZ (US); Tengteng Tang, Tempe, AZ (US)

(21) Appl. No.: 19/231,062

(22) Filed: Jun. 6, 2025

Related U.S. Application Data
(60) Provisional application No. 63/657,453, filed on Jun. 7, 2024.

(51) Int. Cl. B29C 64/165; B29C 64/194; B33Y 10/00; B33Y 30/00; B33Y 40/00

(52) U.S. Cl. CPC B29C 64/165; B29C 64/194; B33Y 10/00; B33Y 30/00; B33Y 40/00

(57) ABSTRACT

A method of forming a polymer composite includes forming an array of pillars of a polymer material, each pillar of the array of pillars separated by intermediate spaces, weaving, waving, and/or knitting a continuous fiber in a controlled pattern within the intermediate spaces between the array of pillars, and encapsulating the continuous fiber with a subsequent layer of the polymer material.

### BACKGROUND

Within the advancing domain of advanced manufacturing technologies, leveraging insights from nature has emerged as a fertile source of innovation. Nature, characterized by complex and durable designs, frequently serves as an example for extending the boundaries of manufacturing techniques. While traditional human-centered materials design requires optimization of factors such as strength and ductility, or fracture toughness and stiffness, among many other examples, recent work has shown that structures found in nature often break down those barriers, producing materials with significantly improved properties over anything designed by humans. For example, the extraordinary silk spinning capabilities of spiders have inspired creative approaches to continuous fiber manufacturing (CFM). Additionally, there are certain similarities in setup between a spider's body, nervous system, and silk-producing glands and a 3D printer with its moving frame, control system, and extrusion mechanism. Parallel to spiders crafting strong yet lightweight webs through silk weaving, CFM integrates extended reinforcing fibers within polymer substrates. The procedure builds items by layering material to generate a 3D slice, which has the advantage of generating a complicated shape in a faster cycle time along with a lower expense than traditional manufacturing methods. Some such techniques are direct ink writing (DIW) and fused deposition modeling (FDM). CFM is unique as it can produce highly detailed structures that are also incredibly strong and lightweight. CFM permits the development of elaborate and intricate designs that would otherwise be difficult to achieve with standard manufacturing techniques. The accuracy with which continuous fiber orientation and dispersion are manipulated improves the ability to tailor the material and satisfy the performance needs for the particular application.

During the extrusion process, long reinforcing fibers are inserted into polymer substrates to improve the functionality of the assembled parts. Particularly, thermoset materials are used in DIW and thermoplastics in FDM as the two main material types used by CFM. FDM transforms thermoplastic filament into a semi-molten state using a heating nozzle that is then extruded to create the structure layer by layer through deposition.

Fiber-reinforced composites (FRC), polymer matrix composites (PMC), bio-composites, polymer ceramic composites (PCC), and nanocomposites, can all be printed using the FDM technique. However, fundamental defects observed in objects produced through the FDM process can be summed up as follows: uneven fiber distribution within fiber-reinforced thermoplastic filament; poor bonding between the fibers and matrix, surface roughness resulting from the staircase effect, and shape distortion brought on by residual stresses resulting from a non-uniform temperature gradients. By using SEM image analysis, faults are identified in fiber reinforced FDM print composite. The top surface of the surface porosity and surface roughness of the print, as well as the weak link between the fiber and matrix, are the most noticeable flaws. Compared to FDM, the DIW technology has the advantages of low cost, high molding efficiency, and a larger range of applications. DIW is an extrusion-based layer-by-layer printing technique that involves pressure-driven deposition of a viscoelastic ink through a fine nozzle. One of the limitations of traditional DIW technology, especially in large-scale printing of the structures is that the interface may suffer from structural defects such as trapped gas, voids, or irregularities, resulting in poor interlayer bonding. Furthermore, the removal of the structural defects from the interlayer spaces using high-resolution printing techniques with minimal or no post-printing treatments is a new challenge for researchers in the case of 3D structure development. Even with the growing advancements in the field, the mechanical properties of a 3D printed composite are significantly impacted by fiber alignment. Optimization can be done between the decrease in porosity and the rise in fiber volume fraction. Furthermore, Vat Photopolymerization (VPP), capable of constructing 3D structures with increased speed and precision compared to FDM and DIW, lacks sufficient exploration in CFM. Initially, materials accumulate within the liquid resin tank through light-initiated polymerization, differing from the filament or fiber composite extrusion processes in FDM and DIW. The challenge lies in the absence of effective means for embedding continuous fiber in VPP, whereas FDM and DIW offer potential for CFM through their extrusion-based methods. Despite this, VPP is utilized to create channels for embedding fibers during the printing process, encapsulating the structure to achieve a continuous fiber-reinforced composite after embedding. In view of past efforts, there remains ample room for further advancement, particularly in the programmable control of the spatial distribution of fiber. These difficulties highlight the necessity for creative approaches that push the limits of what can be done to maximize the advantages of CFM.

### SUMMARY

Continuous fiber manufacturing (CFM) has emerged as a significant player in the realm of advanced manufacturing technologies, predominantly due to its capacity to fabricate structures characterized by their intricate complexity, lightweight, and exceptional properties. Most of CFM is developed based on the extrusion process, such as fused deposition modeling (FDM) and direct ink writing (DIW), to achieve the fabrication of polymer matrix with continuous fibers for overall performance reinforcement. Nonetheless, it inevitably introduces a series of challenges, including the formation of voids 112 between adjacent extrusion paths, the potential for delamination 104 between strands 100 or layers, and limitations associated with ensuring proper fiber-to-matrix wetting 108, as shown in FIGS. 1A-1B. In view of the abovementioned deficiencies, the present application details a novel continuous fiber three-dimensional (3D) printing methodology that leverages vat photopolymerization (VPP), continuous fiber writing, and encapsulation. The application delves into the effects of pillar array shape and spatial distribution dimensions on the continuous fiber writing. Three fiber patterns (namely, Weaving, Knitting, and Waving) are numerically defined, each showcasing enhanced mechanical properties in comparison to pure polymer structures and exhibit some residual deformation that serves as a safeguard against catastrophic fragmentation even when subjected to critical stress. Finally, the manufacturing capabilities of single-fiber and multi-fibers reinforced composite and the application in shape memory alloy (SMA) actuator are demonstrated. In sum, the continuous fiber 3D printing approach disclosed herein, enhanced with functional embedded frameworks, revolutionizes the traditional extrusion-based CFM, unlocking extraordinary possibilities.

This technique possesses significant potential for a wide array of applications, such as mechanical metamaterial, dynamic actuation, thermal management, smart optics, 3D electronics, and advanced sensor systems.

In some aspects, the techniques described herein relate to a method of forming a polymer composite, the method including: forming an array of pillars of a polymer material, each pillar of the array of pillars separated by intermediate spaces; weaving, waving, and/or knitting a continuous fiber in a controlled pattern within the intermediate spaces between the array of pillars; and encapsulating the continuous fiber with a subsequent layer of the polymer material.

In some aspects, the techniques described herein relate to a method, wherein each pillar of the array of pillars is formed as a conical frustum, a cylinder, a triangular prism, or a rectangular prism.

In some aspects, the techniques described herein relate to a method, wherein the array of pillars is a first array of pillars, the method further including forming a second array of pillars of the polymer material on the subsequent layer of the polymer material.

In some aspects, the techniques described herein relate to a method, wherein the continuous fiber is a first continuous fiber, the method further including weaving, waving, and/or knitting a second continuous fiber between the second array of pillars.

In some aspects, the techniques described herein relate to a method, wherein the pattern of the first continuous fiber is distinct from the pattern of the second continuous fiber.

In some aspects, the techniques described herein relate to a method, wherein weaving, waving, and/or knitting the continuous fiber includes moving a gripper into a printing area of the polymer composite to tension the continuous fiber about the pillars of the array of pillars.

In some aspects, the techniques described herein relate to a method, wherein weaving, waving, and/or knitting the continuous fiber includes moving a writing head into a printing area of the polymer composite to tension the continuous fiber about the pillars of the array of pillars.

In some aspects, the techniques described herein relate to a method, wherein prior to weaving, waving, and/or knitting the continuous fiber, the method further includes pre-soaking the continuous fiber in the polymer material.

In some aspects, the techniques described herein relate to a method, wherein the array of pillars is formed by curing the polymer material into a pillar base having the array of pillars formed thereon, wherein the polymer material is a liquid polymer resin material that is cured into a solid polymer resin material.

In some aspects, the techniques described herein relate to a method, wherein weaving, waving, and/or knitting the continuous fiber in the controlled pattern includes locating a tip of a gripper or writing head into the intermediate space between adjacent pillars of the array of pillars.

In some aspects, the techniques described herein relate to a method, wherein forming the array of pillars and encapsulating the fibers includes curing the polymer material.

In some aspects, the techniques described herein relate to a method, wherein forming the array of pillars includes submersing at least a portion of a build platform into a resin tank, and wherein encapsulating the continuous fiber with the subsequent layer of the polymer material includes submersing at least a portion of the continuous fiber in the resin tank.

In some aspects, the techniques described herein relate to a method, wherein weaving, waving, and/or knitting the continuous fiber includes overlapping multiple layers of the continuous fiber onto the array of pillars.

In some aspects, the techniques described herein relate to a method, wherein prior to weaving, waving, and/or knitting the continuous fiber, the array of pillars is transported from a build platform of a resin tank to a fiber writing apparatus.

In some aspects, the techniques described herein relate to a method, wherein the array of pillars are formed on a build platform of a resin tank, wherein weaving, waving, and/or knitting the continuous fiber includes weaving, waving, and/or knitting the continuous fiber onto the array of pillars positioned on the build platform.

In some aspects, the techniques described herein relate to an additive manufacturing apparatus including: a build platform positioned relative to a tank containing a polymer material; a projector configured to selectively solidify the polymer material on the build platform in successive layers to form an array of pillars on the build platform; a fiber dispensing head configured to grasp and deposit a continuous fiber; and a controller programmed to move the fiber dispensing head relative to the build platform and deposit the continuous fiber relative to the polymer material in a selected one of a weave, a wave, or a knit.

In some aspects, the techniques described herein relate to an additive manufacturing apparatus, further including a multi-axis robotic arm coupled to the fiber dispensing head and configured to move the fiber dispensing head.

In some aspects, the techniques described herein relate to an additive manufacturing apparatus, wherein each pillar of the array of pillars is formed as a conical frustum, a cylinder, a triangular prism, or a rectangular prism.

In some aspects, the techniques described herein relate to an additive manufacturing apparatus, wherein the fiber dispensing head is configured to deposit the continuous fiber about the array of pillars on the build platform.

In some aspects, the techniques described herein relate to an additive manufacturing apparatus, wherein the fiber dispensing head is coupled to a gantry of a fiber writing apparatus separate and distinct from the build platform.

Other aspects of the present subject matter will become apparent by consideration of the detailed description and accompanying drawings.

### BRIEF DESCRIPTION OF THE DRAWINGS

FIG. 1A illustrates an example of continuous fiber manufacturing.

FIG. 1B illustrates limitations of continuous fiber manufacturing in the prior art.

FIG. 2A illustrates 3D printing with programmable interlocked continuous fiber reinforcements.

FIG. 2B further illustrates 3D printing with programmable interlocked continuous fiber reinforcements.

FIG. 2C still further illustrates 3D printing with programmable interlocked continuous fiber reinforcements.

FIG. 3 Illustrates a 3D printing apparatus configured to print with programmable interlocked continuous fiber reinforcements.

FIG. 4 illustrates cyclic step-by-step and layer-by-layer fabrication of complex structures containing continuous fiber frameworks.

FIG. 5 illustrates different pillar shapes and their associated waving and manufacturing guidance diagrams regarding pillar height, distance, and waving success rate with a highlighted none working zone.

FIG. 6 illustrates a fiber pattern, writing path coordinate, pillar substrate, and fabricated sample of each of weaving, knitting, and waving.

FIG. 7A illustrates tensile testing of a non-reinforced tensile bar.

FIG. 7B illustrates tensile testing of a tensile bar having weaving reinforcement.

FIG. 7C illustrates tensile testing of a tensile bar having knitting reinforcement.

FIG. 7D illustrates tensile testing of a tensile bar having waving reinforcement.

FIG. 7E illustrates the tensile bars of FIGS. 7A-7D.

FIG. 7F illustrates a stress-strain diagram of the tensile bars of FIGS. 7A-7D.

FIG. 8A illustrates a design with a single layer of continuous fiber inside a polymer matrix.

FIG. 8B illustrates a design with multiple layers of continuous fiber patterns.

FIG. 8C illustrates a dynamic testing of a printed waving actuator having an embedded shape memory alloy fiber.

FIG. 8D illustrates a graph depicting a relationship between actuation speed and applied voltage.

FIG. 8E illustrates a graph depicting a relationship between actuation speed and light loading.

FIG. 8F illustrates a graph depicting a relationship between actuation speed and heavy loading.

FIG. 9 illustrates a fiber writing process utilizing a writing head.

FIG. 10A illustrates a fiber writing apparatus having the fiber writing head of FIG. 9.

FIG. 10B illustrates a close-up perspective view of the fiber writing head of FIG. 10A.

FIG. 10C is a front view of the fiber writing apparatus of FIG. 10A.

FIG. 10D illustrates a first pattern formed via the fiber writing apparatus of FIG. 10A.

FIG. 10E illustrates a second pattern formed via the fiber writing apparatus of FIG. 10A.

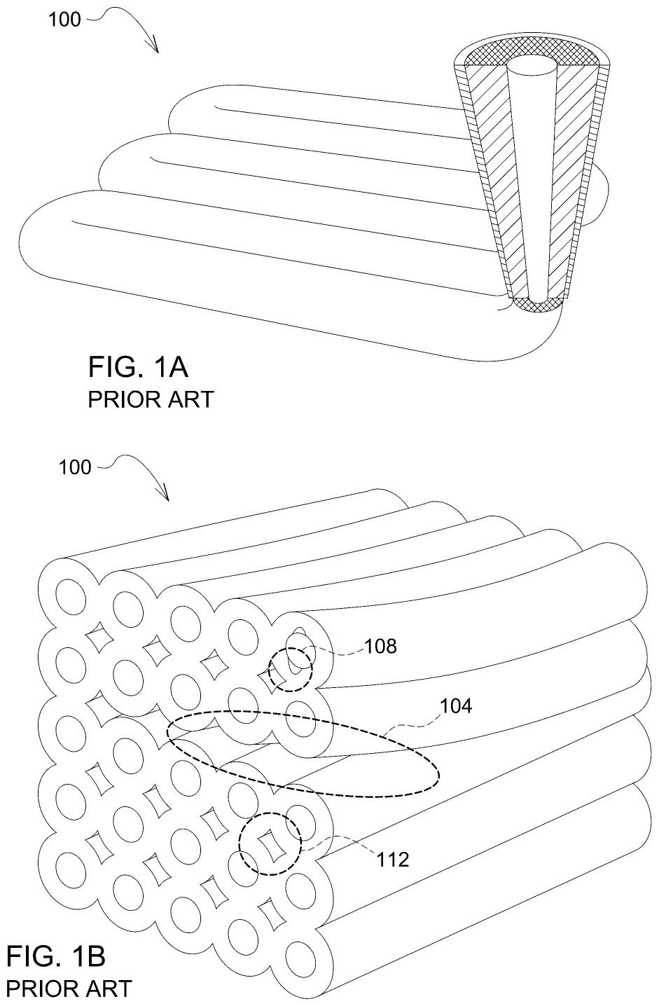

Before any embodiments of the present subject matter are explained in detail, it is to be understood that the present subject matter is not limited in its application to the details of construction and the arrangement of components set forth in the following description or illustrated in the following drawings. The present subject matter is capable of other embodiments and of being practiced or of being carried out in various ways.

### DETAILED DESCRIPTION

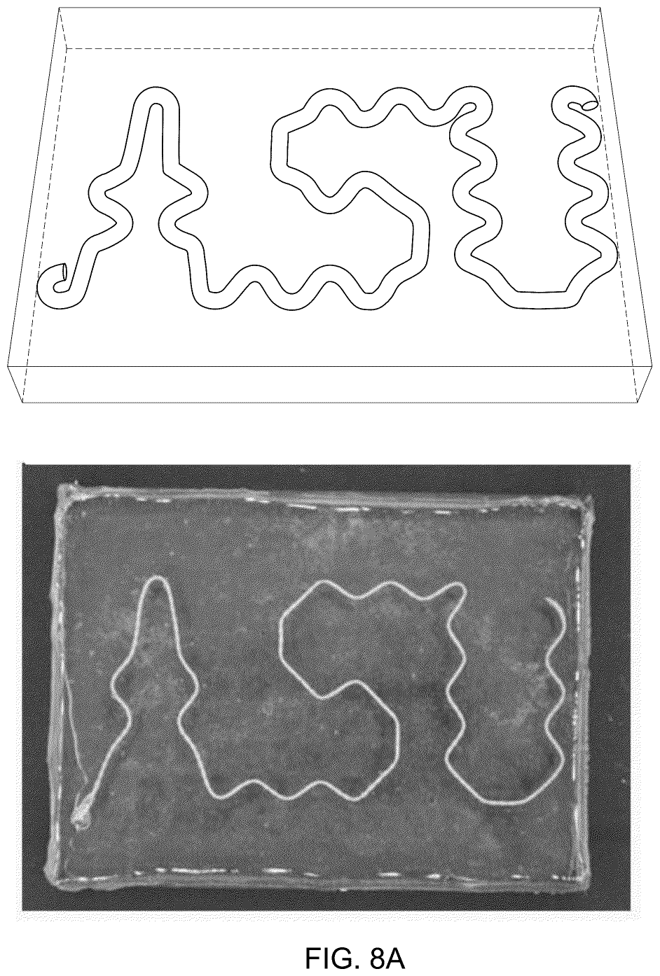

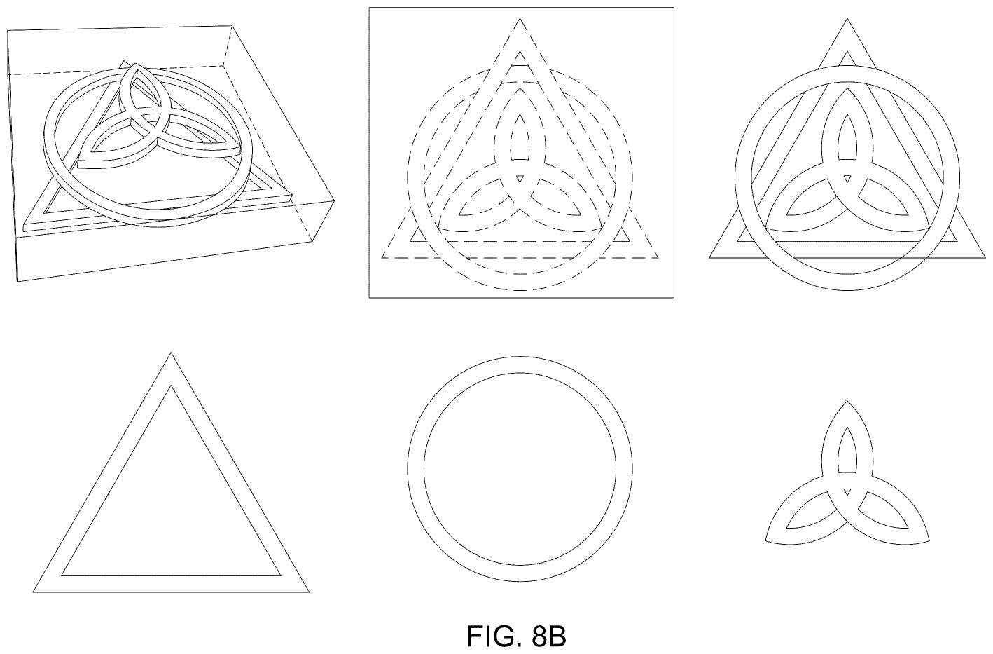

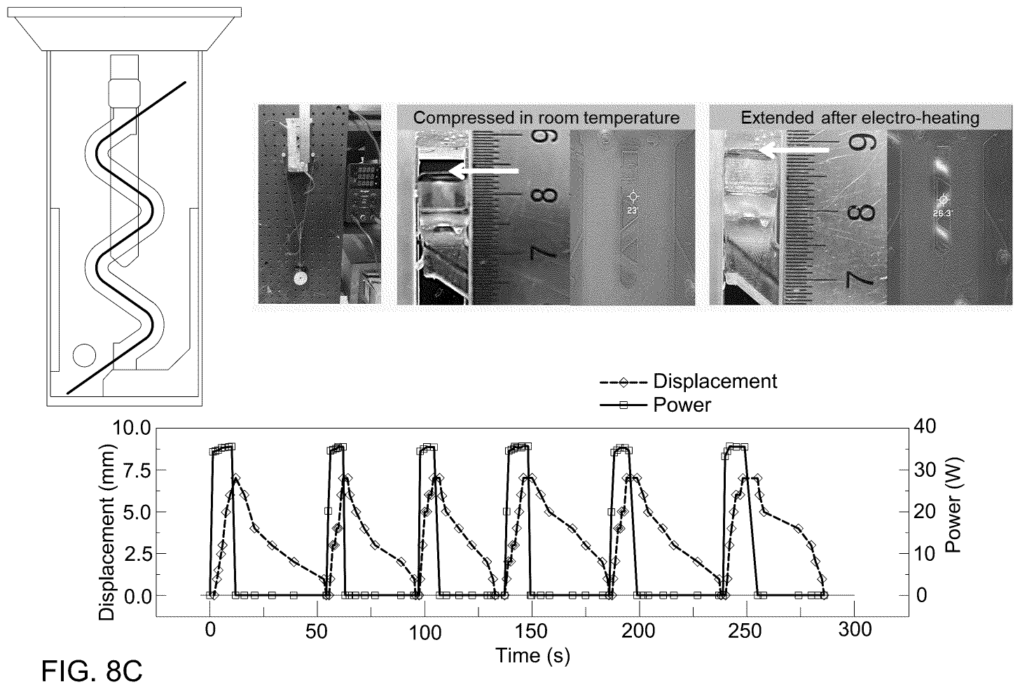

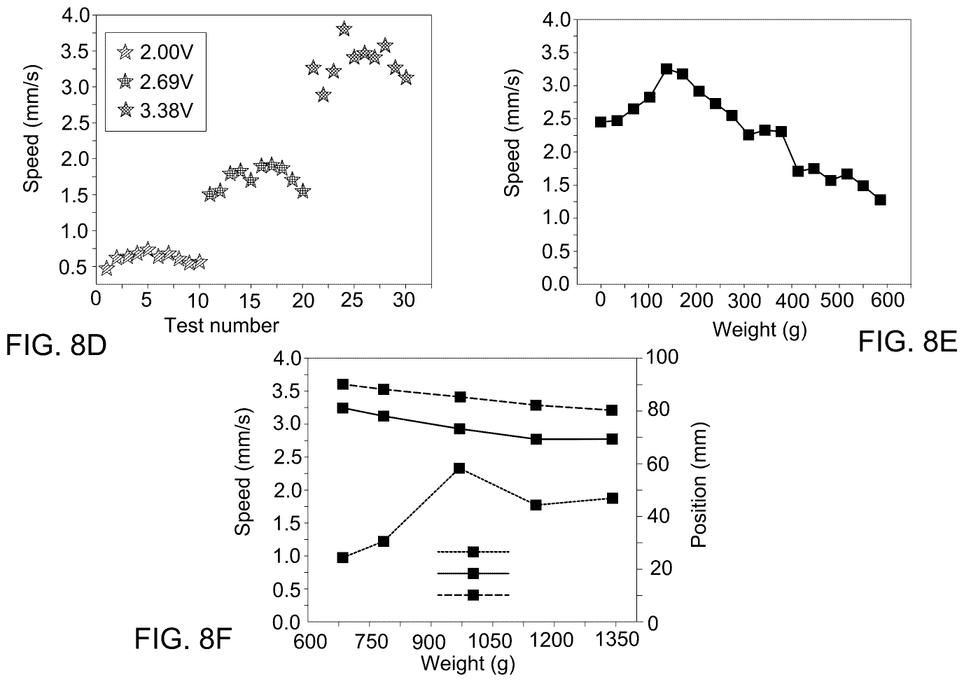

Described herein is a novel continuous fiber additive manufacturing/3D printing process that overcomes the drawbacks of extrusion-based CFM. Using an embedded continuous fiber framework and VPP, the process entails printing pillar substrates strategically and then writing continuous fibers around the pillar array. By analyzing the effects of various pillar shapes and spacings on the effectiveness of fiber writing patterns, namely Weaving, Knitting, and Waving, the process maps the working zone for continuous fiber writing, allowing for the selection of optimal pillar configurations for enhanced manufacturing precision. Tensile simulations and testing reveal that the polymer matrix composites with embedded fiber framework, compared to pure polymer, show considerable improvements in maximum stress and ultimate strain. The mechanical fortification is attributed to a dual-phase fracture mechanism, initiating with the initial cracking of the polymer matrix, and progressing to a controlled fiber/matrix detachment. This process effectively dampens the abrupt failure typically observed in pure polymers, leading to a significant enhancement in durability. Additionally, the method demonstrates flexibility in fabricating both single and multi-fibers embedded structures with complex geometries. The ability to produce complex patterns like the ASU waving pattern, triangles, circles, and Borromean rings are showcased in FIGS. 8A-8B, as discussed in greater detail below. A unique aspect of the method is the seamless integration of successive layers, ensuring robust structural integrity without the need for additional bonding treatments. The demonstration of shape memory alloy (SMA) actuator (FIG. 8C) highlights the proposed method's potential in creating responsive, high-load capacity, and electrothermal driven devices. Overall, the method presents a significant advancement in continuous fiber 3D printing technology and opens new possibilities for the creation of materials and structures with enhanced properties, with potential applications in mechanical reinforcement, electrothermal driven actuation, thermal management, self-sensing systems, and smart integrated electronics.

A method of continuous fiber 3D printing integrates VPP, continuous fiber writing, and encapsulation, as described herein. The method effectively avoids the porosity defects and incomplete polymer matrix/fiber interface wetting and bonding, which are common drawbacks of extrusion-based CFM techniques. The working zone of continuous fiber writing is mapped under various pillar shapes and distributions, facilitating the selection of optimal pillar design parameters for the fabrication of functional embedded fiber frameworks. Shape definitions, fiber writing paths, and coordinate systems of three fiber patterns (e.g., Weaving, Knitting, Waving) and their corresponding pillar bases are defined. Tensile simulations and physical testing both indicate that samples with an embedded fiber framework exhibit significant improvements in maximum stress and ultimate strain compared to pure polymer. This enhancement is attributed to a two-stage process involving the stretching-induced fracture of the polymer matrix followed by matrix/fiber separation. Even after complete polymer fracture, the internally stored fibers maintain the connection between the two ends, thereby preventing catastrophic fragmentation and splattering. Notably, the waving pattern exhibited a maximum stress of 2.42 MPa, doubling the strength of pure polymer, and the weaving and knitting patterns demonstrated a final strain of about 170%, maintained by fibers bridging the extremities. Furthermore, the application potential of this 3D printing technique is showcased by constructing complex, multi-layered structures with embedded fibers in diverse geometrical patterns. The seamless integration of successive layers without the need for additional bonding treatments highlights the efficiency of the process and potential of the process for creating functional polymer composite with sophisticated, durable continuous fiber reinforcements that are both functional and intricately designed. The fabricated SMA actuators utilize the characteristic of electrical heating-induced deformation, offering significant load capacity and rapid response rates. Through enhanced path planning and optimization, the fiber writing duration may be reduced. This entails the development of tailored designs for the fiber gripper and facilitating the accommodation of diverse writing strategies. Further, the method pioneers the creation of 3D deformable fibers equipped with the capability to sense tension, thermal changes, magnetic fields, or electrical stimuli. This approach addresses current limitations and fosters a more streamlined and CFM method, while simultaneously paving the way for innovative applications in responsive structures and sensor technologies. Overall, this method and system not only highlight the potential of this advanced 3D printing technique in enhancing mechanical and thermal properties of fabricated structures but also opens new possibilities for creating efficient and responsive actuators, mechanical metamaterial, thermal management devices, 3D electronics, and advanced sensor systems.

The material used in the method may include, in some embodiments, Flexible 80A, a translucent resin, Kevlar fiber, fluorescence dyes, and/or a shape memory alloy. In some embodiments, the fluorescent dyes are mixed with Flexible 80A to fabricate polymer fibers with different fluorescent color.

The continuous fiber 3D printing method integrates a top-down VPP process with fiber writing techniques. The fabrication of each layer containing fibers involves three distinct steps. Initially, the process begins with 3D printing a pillar base. The pillar created by computer aided design (CAD) software is sliced into binary black-and-white mask images and projected by a projector. The two-dimensional beam with a specific shape successively solidifies thin layers with a thickness of about 50 μm layer by layer. The building platform cyclically descends to recoat the surface of the solidified layer with a new liquid layer, enabling the vertical accumulation of solidified layers to form a 3D pillar structure. The pillar structure is formed as an array of pillars 208 separated from one another by intermediate spaces. In the illustrated embodiment, the pillars 208 are formed in a rectangular array of rows and columns. In other embodiments, the array may be non-rectangular, including circular or polar arrays and irregular arrays. In some embodiments, the intermediate spaces between the pillars 208 are regular (i.e., equal in size). Subsequent to the pillar formation, the process transitions to the fiber writing stage. Driven by the three-axis motion platform, a gripper enters the printing area and navigates through the pillars in the XY plane, simultaneously tensioning the fiber to tightly bind it around the pillars to avoid moving or floating during the following printing process. Once the desired pattern is fabricated, the gripper exits the printing area, awaiting the completion of pillar printing for the next layer before commencing the weaving process again. It is noteworthy that, unlike the straightforward writing around pillars required for the Waving pattern, the fiber shuttles between previously laid fibers and avoids void defects in Weaving and Knitting due to the increased nodes and the complexity of the pattern. As such, the leading end of the fiber is connected to a rigid needle. The gripper inserts the needle on one side of the preceding fiber and moves to the other side to pull out the needle, completing the interlacing of the fiber between the preceding fiber and pillar. This step increases the structural integrity and design of the final product. Finally, the printing process culminates with the encapsulation phase. Here, after the completion of fiber writing, the building platform descends, immersing both the pillar base and the woven fibers in the resin solution. This is followed by a strategic projection of the corresponding mask image, which serves to solidify the solution layer, effectively encapsulating the fibers. By iteratively performing these three steps, it becomes possible to fabricate complex structures with multiple continuous fiber layers. This technique allows for a programmable embedding of fibers within the polymer matrix, endowing the resulting structure with tailored mechanical and thermal properties. This method marks a significant leap in 3D printing technology, offering unprecedented control over the internal configuration and functional attributes of the fabricated objects.

The curvilinear coordinate in COMSOL Multiphysics is used to define the center path of the fiber. The curvilinear coordinate system offers the capability to establish a coordinate framework that aligns with the curves of a geometry, allowing for the definition of anisotropic material properties or anisotropic physics. In this instance, the diffusion method is employed to solve Laplace's equation, yielding a scalar potential which is considered as the first basis vector:

$$∇ \cdot ( ∇ U ) = 0 \\ v = \frac{- ∇ U}{\vert - ∇ U \vert} \qquad ( 1 )$$

where U is the local diffusion velocity, v is the first basis vector. The second basis vector is manually defined (here is x), and the third base vector is obtained by taking the cross product of the two:

$${e}_{1} = \frac{v}{\vert v \vert} \\ {e}_{2} = \frac{x - ( x \cdot {e}_{1} ) {e}_{1}}{\vert x - ( x \cdot {e}_{1} ) {e}_{1} \vert} \\ {e}_{3} = {e}_{1} \times {e}_{2} \qquad ( 2 )$$

where e₁, e₂, e₃ are mutually orthogonal unit vectors. Hence, spatial vectors that vary along the direction of the fiber can be obtained.

Regarding tensile testing, the fiber is considered as linear elastic material, Hooke's law defines the relationship between stress tensor and the elastic strain tensor:

$$σ = {σ}_{ex} + C : {ε}_{el} = {σ}_{ex} + C : ( ε - {ε}_{inel} ) \qquad ( 3 )$$

Here, C represents the fourth-order elasticity tensor, and: denotes the double-dot tensor product (or double contraction). The elastic strain εₑₗ is defined as the disparity between the total strain & and all inelastic strains εᵢₙₑₗ. Additionally, there might be an additional stress contribution σₑₓ that includes components from initial stresses and viscoelastic stresses. As for the material parameters, the Young's modulus and Poisson's ratio of Flexible 80A and Kevlar fiber are set as 3.5 MPa/160 GPa and 0.3/0.26 respectively. The prescribed displacement is 10% tensile strain. The material parameters of other materials may be different than those described above.

To facilitate the application of continuous fiber 3D printing in the field of actuators, a methodical approach is adopted. The process begins with the printing of a wavy-shaped polymer matrix, into which SMA fibers are integrated as the primary source of actuation. For controlled actuation, the device is strategically positioned in a vertically oriented 3D printed fixture, which confines the actuator's deformation to a linear motion. One end of the actuator is anchored, while the other is connected to a slider attached to a weight which makes actuator compressed. The activation of the SMA fibers is achieved through the application of an electric voltage, causing the fibers to heat and stretch. This stretch enables the compressed actuator to counteract the weight's gravity force and propel the slider upwards. Once the power supply is disconnected, the SMA cools down and is compressed and bent under the action of a heavy object, causing the slider to move downward to the initial position. By intermittently switching the power on and off, the actuator undergoes a cyclic motion of compression and expansion. The innovative use of SMA fibers within a 3D printed polymer matrix represents a significant advancement in actuator technology, offering precise control and efficient energy utilization in actuator-driven systems.

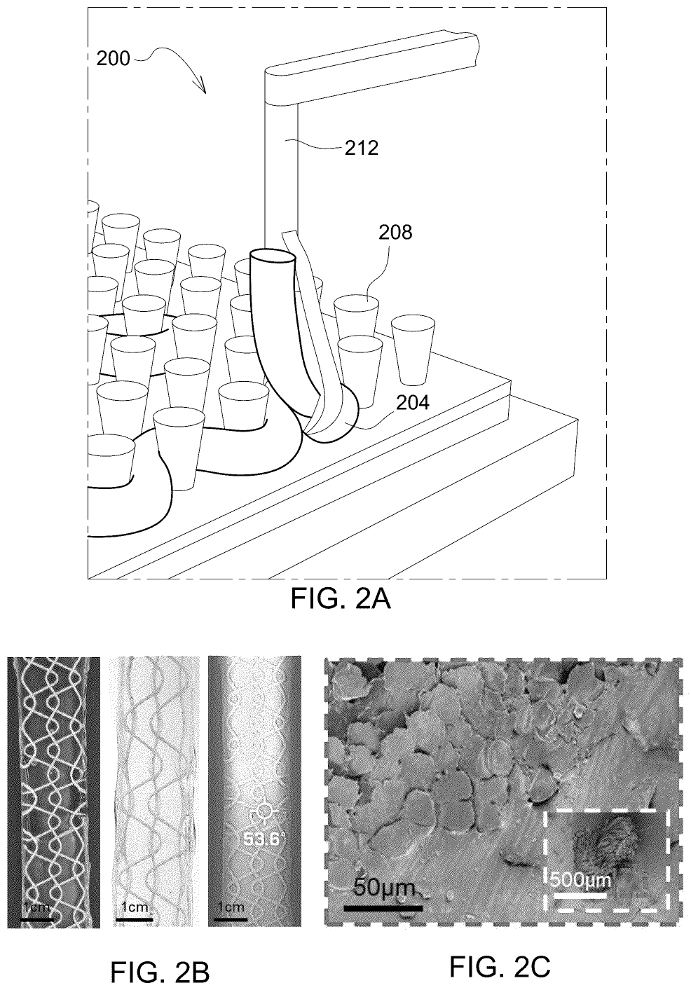

A FLIR ONE thermal camera generates the IR image of the heated waving tensile bar, as shown in FIG. 2B. The micro surface morphology of fiber/matrix interface as shown in FIG. 2C, fiber/matrix fracture cross-section is prepared via an Auriga scanning electron microscopy (SEM).

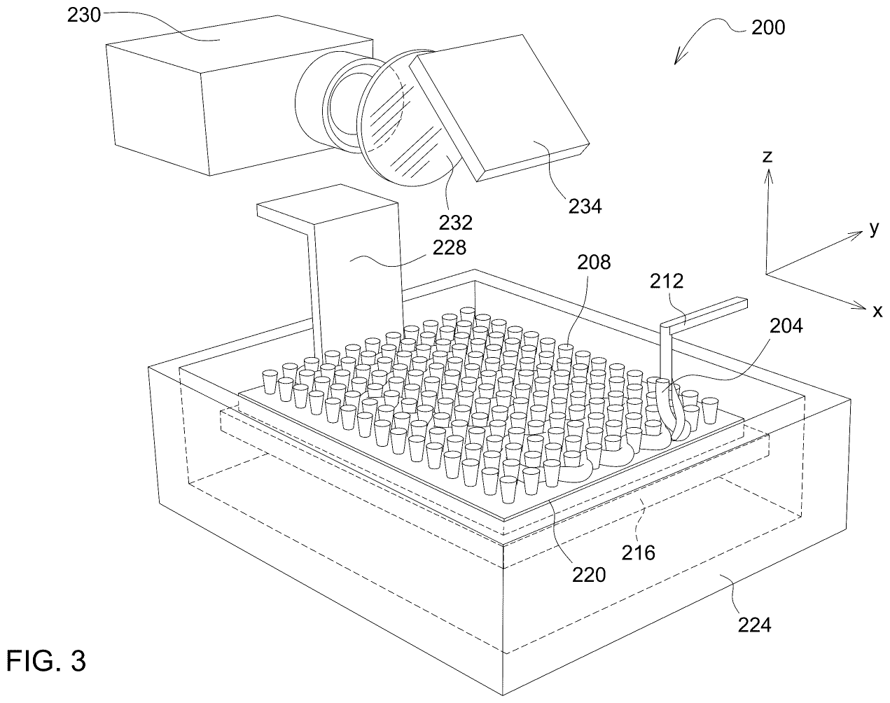

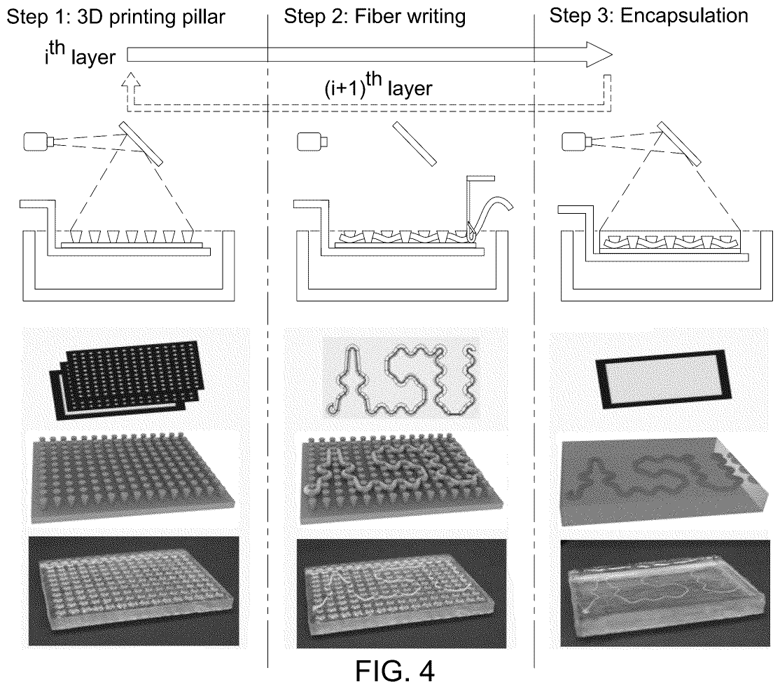

As depicted in FIG. 2A, the system 200 employs a continuous fiber 204 that is navigated between previously printed pillars 208 along a predetermined path with the assistance of a gripper 212, and subsequent encapsulation results in structures with varying patterns. For instance, the waving pattern, when subjected to tensile stress parallel to the fiber direction, exhibits mechanical reinforcement due to enhanced wetting of the polymer matrix/fiber interface, as evidenced by SEM imaging. Additionally, thermal imaging indicates a higher thermal conductivity of the fibers. The detailed manufacturing process is described with respect to FIGS. 3-4. The process and system 200 employ a top-down 3D printing approach, with the optical component comprising a digital micromirror device (DMD) projector 230, a convex lens 232, and a reflective mirror 234. The resin tank 224, a sinking building platform 216, and a fiber dispensing head (as shown, a fiber gripper 212) form the main components of the printing apparatus 200. The resin tank 224 includes an interior chamber for housing a liquid resin material such as Flexible 80A, as discussed above. As shown, the build platform 216 is capable of movement in the Z-axis (up and down) within the liquid resin material in the resin tank 224, and the fiber gripper 212 is movable along any of the three axes (x-axis, y-axis, and z-axis) relative to the resin tank 224 and build platform 216 to move the fiber 204 to various locations along the build platform 216. FIG. 4 illustrates cyclic step-by-step and layer-by-layer fabrication of complex structures containing continuous fiber frameworks.

As shown in FIGS. 3-5, during the printing of the i^{th} layer containing fiber, the initial step involves printing the pillar base 220 required for fiber writing. Optimal pillar shapes and distances are designed using computer-aided design (CAD) software. The CAD model is then sliced into a series of binary black-and-white mask images, which are projected by the DMD projector 230, causing the liquid resin polymer within the resin tank 224 to solidify under the two-dimensional light beam onto the building platform 216. Subsequently, the sinking building platform 216 recoats the structure with an uncured layer of resin solution, and the process of projecting mask images and lowering the platform 216 layer-by-layer creates the pillar base 220.

The second step, fiber writing, involves using the gripper 212 to inscribe the fiber 204 along a predetermined path between the pillars 208, such as the ASU waving pattern shown in FIG. 4. During this process, moderate tension on the fiber 204 is maintained to eliminate excessive slack, which can otherwise lead to the fiber 204 disengaging from the pillars 208 and distorting the intended pattern. The third step is encapsulation. After fiber writing, the building platform 216 is lowered, and a new layer of resin solution covers the fiber 204 and pillars 208. A light beam is then projected to encapsulate the fiber 204. Repeating this three-step process enables the creation of the (i+1)^{th} layer and any complex multi-layered structure. By integrating top-down VPP with fiber writing, significant improvements in bonding between the polymer matrix and fibers, as well as between layers, are achieved. This printing process effectively circumvents the drawbacks of traditional CFM. As described below, pillar shape parameters can affect the manufacturing success rates and the fiber pattern can affect the mechanical properties.

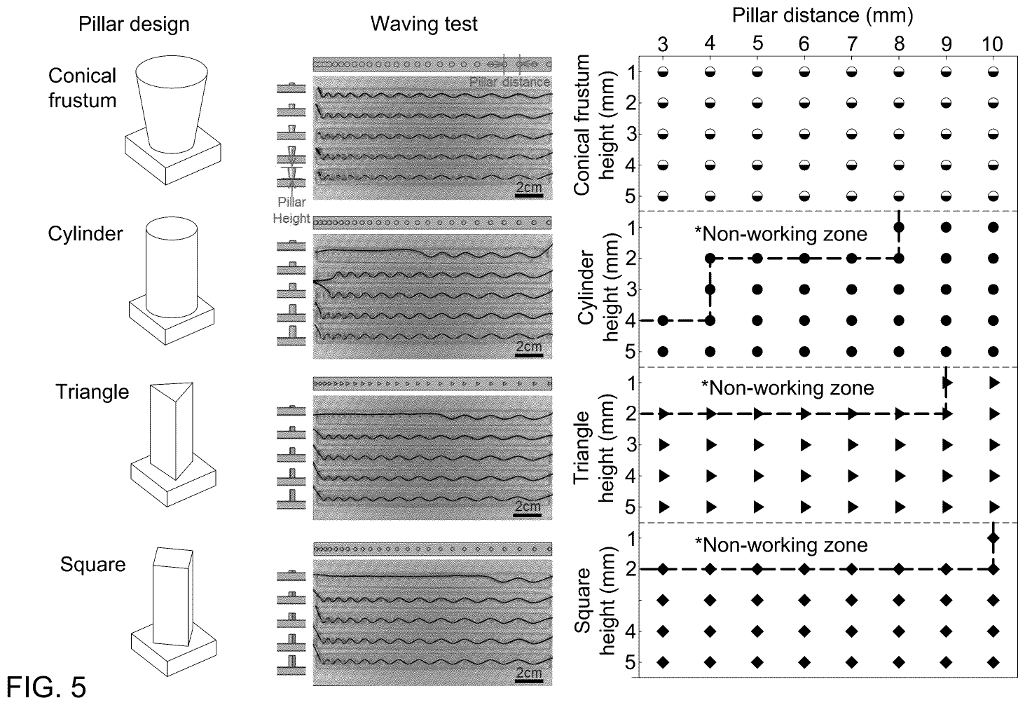

With reference to FIG. 5, four distinct pillar shapes (for pillars such as the pillars 208 shown in FIG. 3) are designed: conical frustum, cylinder, triangle, and square. A waving fiber approach is used to establish a correlation between the fabrication parameters of the pillars and the success rate of fiber routing. The dimensions of the pillar shapes are as follows: the conical frustum has a bottom diameter of 2 mm with a slope of 8 degrees, the cylinder has a diameter of 2.75 mm, and both the equilateral triangle and square are inscribed in a circle with a diameter of 2.75 mm. As illustrated in the waving test portion of FIG. 5, the height of the pillars varies from 1 mm to 5 mm from top to bottom, while the distance between the pillars increases from 3 mm to 10 mm from left to right. The fiber is woven in a waving pattern between these pillars. Experimental results indicated that for shapes other than the conical frustum, fiber weaving was unsuccessful when both the height and distance of the pillars are below certain values. For example, with cylinder pillars of 1 mm height, successful fiber traversal only occurs when the distance between the pillars exceeds 8 mm. Similarly, for the triangle and square pillars, the required distances were 9 mm and 10 mm, respectively.

The non-working zones for fiber waving are represented in the Pillar Distance portion of FIG. 5. Notably, for the cylinder pillar, the limitation was not only at a height of 1 mm. When the height was 2 mm or 3 mm and the distance was 3 mm, the fiber could not weave between the pillars. This is attributed to the higher curvature required for successful fiber waving in these configurations, which increases the bending stress on the fiber. Thus, smaller pillar heights and distances fail to adequately constrain the fiber, leading to unsuccessful weaving. In contrast, the conical frustum, with its tapered structure, effectively constrains the fiber, enabling successful weaving across all pillar distribution parameters. This distinct behavior of the conical frustum highlights its potential for more versatile and successful fiber weaving in complex 3D printed structures.

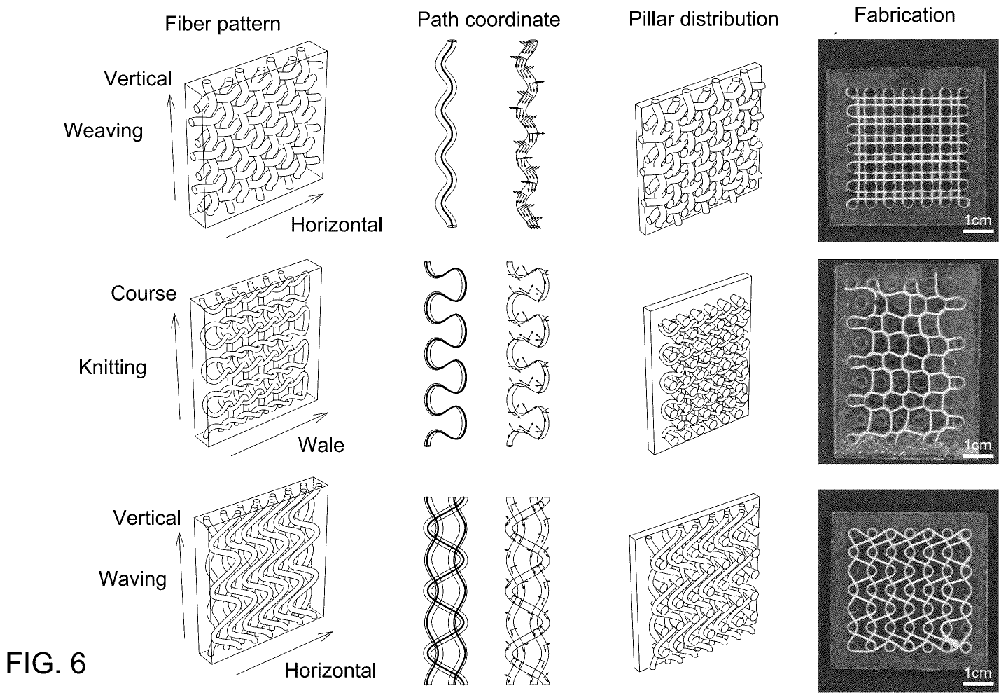

FIG. 6 illustrates three different fiber writing paths around the pillars and their corresponding mechanical properties. The three distinct fiber writing paths include weaving, knitting, and waving. In weaving, as shown in the first row of FIG. 6, fibers run parallel in both horizontal and vertical directions and periodically cross and superimpose each other between two directions. The second row of FIG. 6 depicts single jersey knitting, composed of courses along the fiber direction and wales in the perpendicular direction, where adjacent fibers in the wale direction are interlocked. The distinct appearance of the framework's front and back sides arises from the interlocking pattern of the loops. From a mathematical perspective, this configuration is characterized as a one-course repeat structure. This implies that the identical loop structure is consistently replicated across successive courses (which are the vertical columns of loops) and wales (the horizontal rows of loops). This repetitive pattern of loops in both the vertical and horizontal orientations contribute to the unique visual and structural characteristics of the framework. As illustrated in the third row of FIG. 6, waving involves two layers of fibers with identical periodicity, but varying amplitudes superimposed upon each other.

The second column of FIG. 6 presents the individual writing paths of the fibers and the coordinate definitions used for testing the mechanical properties along the fiber axis. The third column of FIG. 6 displays different pillar designs corresponding to each fiber pattern. In both Weaving and Waving, adjacent fibers run parallel, thus sharing a similar pillar design. However, in Knitting, where fibers intersect in the course and wale directions, the corresponding pillar structure differs from that in Weaving and Waving. Finally, the fourth column of FIG. 6 shows the manufacturing outcomes of the fibers written between the pillars. These results demonstrate a high degree of congruence with the intended designs. A review of the weaving, knitting, and waving paths not only enhances understanding of the interplay between fiber writing techniques and mechanical properties but also underscores the relevance of precise pillar design in achieving desired fiber configurations and functionality in advanced manufacturing processes.

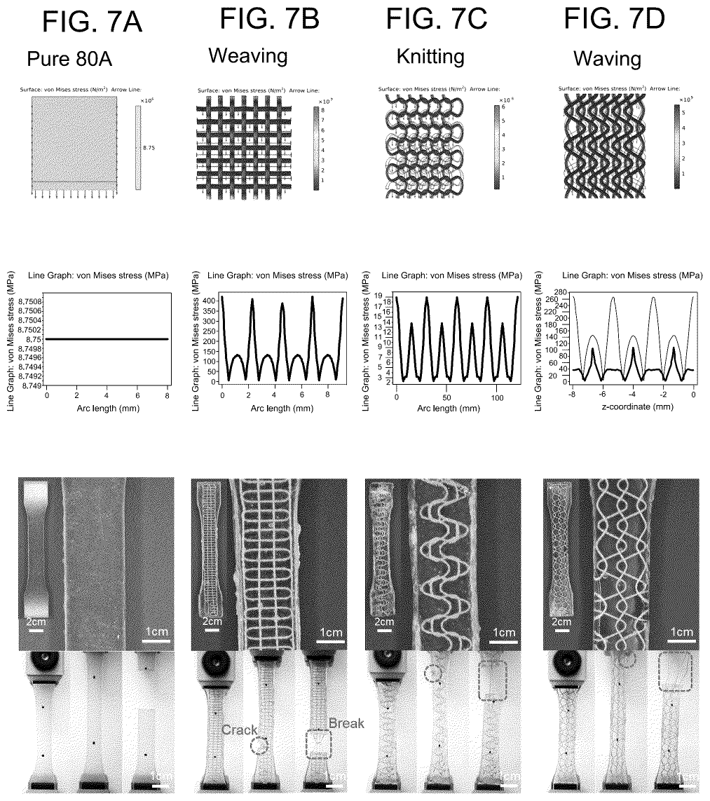

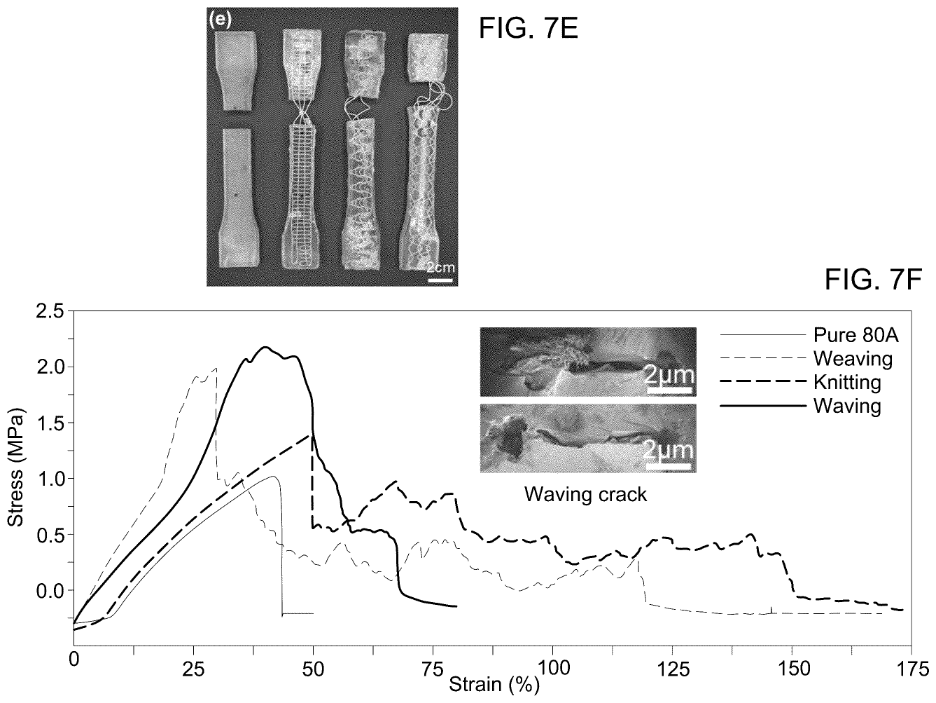

Upon examining various fiber writing methods, FIGS. 7A-7D illustrate the reinforcing effect of fibers on a polymer matrix. Pure 80A polymer is used as a control group to demonstrate the tensile properties of the polymer and is shown in FIG. 7A. The previously defined methods of Weaving, Knitting, and Waving are embedded into the polymer matrix to form polymer/fiber composites. Mechanical simulations reveal preliminary mechanical reinforcement characteristics of the embedded fibers, as illustrated in the first row of each of FIGS. 7A-7D. The displacement of the material during tensile stretching is indicated by red arrows. The second row of each of FIGS. 7A-7D displays the stress variations along the central axis of the polymer (in FIG. 7A) or along the axis of the fiber (in FIGS. 7B, 7C, and 7D). The stress graph for Pure 80A shows uniform stress distribution within the material, reaching a stress of 8.75 MPa at a strain of 10%. With embedded fibers, the stress in the composite is predominantly concentrated on the fibers. The second row of FIG. 7B shows that the stress inside the vertical fibers varies periodically along the length of the fiber, corresponding to the vertical fibers repeatedly crossing the horizontal ones. The first row of FIG. 7B indicates that the stress in the vertical fibers is higher due to the tensile load being applied in the vertical direction. Similarly, the waving fibers in FIG. 7D exhibit analogous stress variations. In the second row of FIG. 7D, the blue line represents fibers with smaller amplitude, which have less reserve for deformation under tension, whereas the green line, representing fibers with larger amplitude, exhibits lower stress due to greater resistance to tensile deformation. Unlike the significant peak differences in the second rows of FIGS. 7B and 7D, the stress variations in the second row of FIG. 7C are more frequent and the difference between adjacent peaks is smaller. This suggests that the knitting pattern more effectively distributes tensile stress, as the fibers in the course and wale directions are interlocked, allowing stress in the longitudinal fibers to be effectively transferred to the transverse ones. A side-by-side comparison of the tensile bars of FIGS. 7A-7D is shown in FIG. 7E.

These simulation characteristics are also fully reflected in the physical tensile testing of the samples, as shown in the third rows of FIGS. 7A-7D as well as FIG. 7F. The Pure 80A tensile bar experiences a rapid fracture after reaching a strain of 43.5%, with the stress abruptly dropping from a peak of 1.28 MPa to 0 MPa. Such sudden and catastrophic fractures are undesirable in certain engineering applications, highlighting the advantages of the three types of fiber composites. The final strain of the fiber-embedded samples is greatly improved, such as 150% for weaving, 174% for knitting, and 80% for waving. As shown in the third row of FIG. 7B, a crack appears at one end of the tensile bar at a strain of 30%, rapidly propagating until the polymer matrix fractures. However, the embedded fiber continues to link the two ends of the tensile bar, preventing an immediate drop to 0 MPa. Instead, the gradual separation of the fiber and polymer matrix and the slow release of the stored fiber in the polymer matrix occurs until the strain reaches 150%, when the fiber and polymer completely separate, and the tensile stress disappears. Similar phenomena are observed in the knitting pattern. Although the peak stress of 1.65 MPa was slightly lower than the 2.25 MPa of the weaving pattern, the stress sustained by the fibers inside the knitting tensile bar remains consistently higher than that of the weaving bar even after complete fracture of the polymer matrix, with a strain reaching up to 174%. This is explained by the simulation results, where the stress in the course direction could effectively spread to the wale direction, allowing the knitting bar to sustain greater stress after fracture.

Lastly, due to the alignment of the waving fibers with the direction of tension, the waving fibers endure the highest stress among the four bars, reaching 2.42 MPa in the tensile experiment. However, as the deformation reserve of the waving tensile bar was determined by fibers with smaller amplitude, the separation of fiber and polymer matrix occur more rapidly compared to weaving and knitting, resulting in the disappearance of tensile stress at a strain of 80%. It is evident that it is the delamination in the second stage that gives the entire structure larger strain values. When exclusively examining the initial stage of fracture, the strain values for weaving, knitting, and waving patterns are 30%, 50%, and 48%, respectively, whereas Pure 80A demonstrates a strain value of 43.5%. In summary, the tensile bar printed with Pure 80A experiences catastrophic fracture when subjected to excessive tension, characterized by a sudden drop in stress while the fracture of a polymer matrix internally filled with fibers under tensile stress occurs in two stages: first, the fracture of the polymer matrix, and then the gradual delamination of the fiber from the polymer matrix. This stepwise fracture and separation effectively prevent the catastrophic failure observed in pure polymers. The reserve for deformation stored in the fiber patterns efficiently connects the fractured polymer, preventing splattering and secondary disasters, which has significant implications for preventing catastrophic failures in tensioned components in practical applications.

To demonstrate the manufacturing flexibility and potential applications of the 3D printing method involving embedded continuous fibers proposed in this study, a single-layer fiber structure is fabricated and embedded with the ASU waving pattern, as shown in FIG. 8A. Subsequently, to showcase the capability of multi-layer printing, three types of resin (e.g., 80A) polymer materials mixed with different fluorescent dyes are prepared and fibers in shapes of a triangle, circle, and Borromean rings are printed using these mixtures (FIG. 8B). During the manufacturing process, the first step involves preparing a substrate with a pre-designed micro-groove in the shape of a triangle for the first layer and the triangle fiber is then embedded into the micro-groove. Following this, the building platform is lowered until the sample is completely immersed in the resin (e.g., 80A) solution. A square-shaped light beam is then projected to solidify and encapsulate the triangle fiber. This procedure is similarly applied for the second and third layers, resulting in a multi-layered structure with different fibers embedded within each layer. The advantage of this manufacturing process lies in the natural bonding between adjacent layers, eliminating the need for additional treatment to link the layers. The substrate of each successive layer naturally solidifies on top of the preceding one, ensuring a tight bond between layers. This approach not only simplifies the manufacturing process but also ensures a robust structural integrity of the multi-layered composite, showcasing the versatility and applicability of this novel 3D printing technique for creating complex, fiber-embedded structures.

To test the SMA actuator, a basic fixture is designed and printed as shown in FIG. 8C. The fixture is a casing that holds the SMA actuator and constrains it in a ID movement to keep it aligned and thus provide a repeatable motion that can be used to test the performance of the actuator under different power and load conditions. The actuator has an attachment to connect different loads to the top of the coil, as well as a basic linear measurement reference to take testing data readings. The fixture is mounted on a vertical surface and the SMA actuator is connected to a 300 W power source with a maximum amperage of 10 A. Due to the low resistance of the SMA actuator, the maximum amperage during testing is reached while the voltage was still only 3.38 V. To ensure a more reliable testing, multi-purpose oil is used to lubricate all sliding surfaces. Four different tests are conducted, with the purpose of characterizing different aspects of the SMA actuator. Tests are conducted with a fixed load but with varying voltages, fixed voltage but with varying load, fixed voltage with higher loads (upwards of 1 kg), and a fixed voltage and load with intermittent actuations in the same timeframe.

The first test, as shown in FIG. 8D, included testing the average actuation speed when applying a constant load of 145.2 g and by varying the applied voltage. Thirty tests were conducted, ten times each for 2V, 2.69V, and 3.38V. The voltage interval is 0.69V for each step, but the average speed increased more when jumping from 2.69V to 3.38V. The standard deviation of the speed increased as the voltage increased. The highest average speed was 3.34 mm/s in the case of applying 3.38V, attesting to a fast response rate of the actuator. The second test, as shown in FIG. 8E, included varying the load when 3.38V voltage and 10.2 Amp are used. The test was done from a 0 g load to a 585.65 g load with increments of 34.45 g. A total of 18 tests were done, and the SMA actuator was left to cool down for 1 minute after each test to ensure reliable data. The general trend was for the average speed of the actuation to slow down as more weight was added, but at the beginning it slightly increased because a small load was beneficial to the performance of the SMA actuator.

The third test, as shown in FIG. 8F, is similar to the second test, but with the purpose of characterizing the behavior of the SMA actuator with higher loads, and until the actuator ceased movement. This test is performed with a 3.38V and 10.2 A. With higher loads, there was not a clear pattern with speed, as the coil does not reach the end of the stroke on these tests. To see a clearer pattern on the behavior of the SMA actuator, it is helpful to refer to the displacement plot. The bottom points on the plot are the location of the top end of the coil with the load on, but no power applied. The top points are the final location after turning on the coil. As weight increases, the starting point is lower but reaches less high after turning it on. The relationship between the start and end points appears linear to the addition of more load, but the stroke of the actuator remains constant even when a higher load is applied. The highest load moved by the actuator under these power settings is 1.526 kg. When performing the testing it is also recorded that soon after the actuator stops expanding, it quickly overheats as its temperature increased. The voltage is controlled to keep the maximum temperature under a safety limit. The fourth test, as shown in FIG. 8C, includes using a fixed load of 685.65 g and a power setting of 3.38V and 10.2A to characterize the behavior of the actuator when intermittently being turned on and off. When the power is turned on, the actuator quickly extends. Due to a mechanical limit on the fixture, the stroke achieved on this test is 7 mm. Once the end of the stroke is reached, the power is turned off, and the SMA actuator slowly retracts as it cooled down. Once the actuator reaches the start point, the process is repeated. It takes more time for the actuator to cool down and retract than it does to heat up and expand when this power setting is used.

The description details a method of continuous fiber 3D printing that integrates VPP, continuous fiber writing, and encapsulation. This method effectively avoids the porosity defects and incomplete polymer matrix/fiber interface wetting and bonding, which are common drawbacks of extrusion-based CFM techniques. The working zone of continuous fiber writing is mapped under various pillar shapes and distributions, facilitating the selection of optimal pillar design parameters for the fabrication of functional embedded fiber frameworks. The description details the shape definitions, fiber writing paths, and coordinate systems of three fiber patterns (Weaving, Knitting, Waving) and their corresponding pillar bases. Tensile simulations and physical testing both indicate that samples with an embedded fiber framework exhibit significant improvements in maximum stress and ultimate strain compared to pure polymer. This enhancement was attributed to a two-stage process involving the stretching-induced fracture of the polymer matrix followed by matrix/fiber separation. Even after complete polymer fracture, the internally stored fibers maintain the connection between the two ends, thereby preventing catastrophic fragmentation and splattering. Notably, the waving pattern exhibits a maximum stress of 2.42 MPa, doubling the strength of pure polymer, and the weaving and knitting patterns demonstrated a final strain of about 170%, maintained by fibers bridging the extremities. Furthermore, the application potential of this 3D printing technique is showcased by constructing complex, multi-layered structures with embedded fibers in diverse geometrical patterns. The seamless integration of successive layers without the need for additional bonding treatments highlights the process's efficiency and potential for creating functional polymer composite with sophisticated, durable continuous fiber reinforcements that are both functional and intricately deigned. The fabricated SMA actuators utilize the characteristic of electrical heating-induced deformation, offering significant load capacity and rapid response rates. Overall, the present description and drawings not only highlight the potential of this advanced 3D printing technique in enhancing mechanical and thermal properties of fabricated structures but also open new possibilities for creating efficient and responsive actuators, mechanical metamaterial, thermal management devices, 3D electronics, and advanced sensor systems.

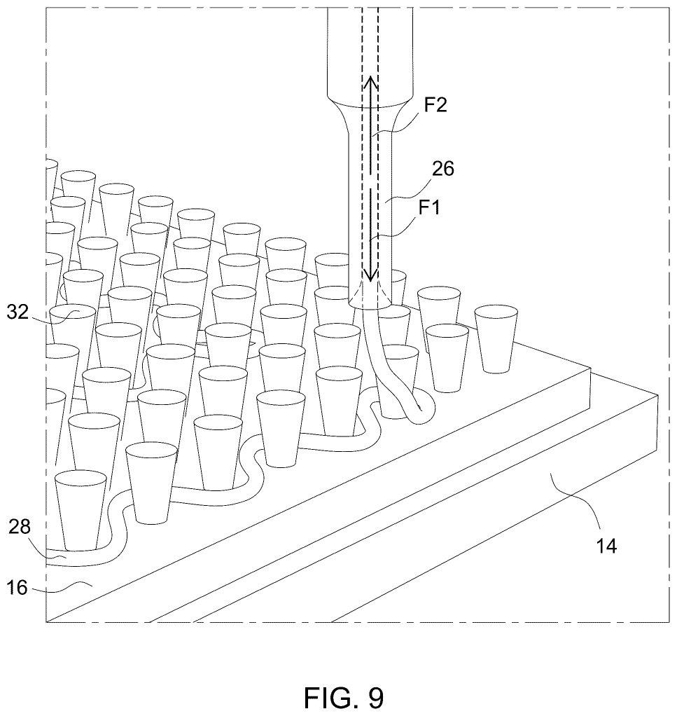

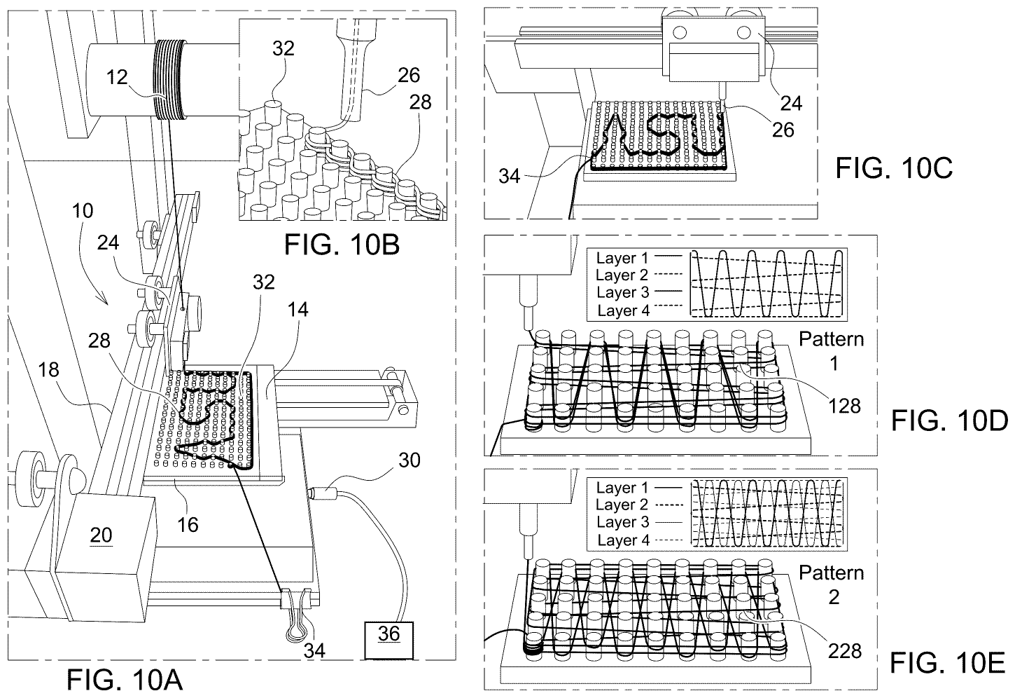

The proposed continuous fiber 3D printing method may be a hybrid process that integrates a top-down vat photopolymerization process with various fiber writing techniques. For example, a process begins with 3D printing a pillar base by employing a top-down 3D printing approach, with the optical component comprising a digital micromirror device (DMD) projector and a reflective mirror. The resin tank and a sinking building platform form the main components of the printing apparatus. The pillar created by 3D modeling is sliced into binary black-and-white mask images and projected by a projector. The two-dimensional UV beam with a specific shape successively solidifies thin layers with a thickness of 50 μm layer by layer. The building platform cyclically descends to recoat the solidified layer's surface with a new liquid layer, enabling the vertical accumulation of solidified layers to form a three-dimensional pillar structure. Subsequent to the pillar formation, the pillar base transfers to the fiber writing stage which utilizes a fiber writing apparatus 10 illustrated in FIG. 10A. In some embodiments, weave patterns require fibers to be interlaced across different layers, the process adopts a manual approach to weave the fibers directly around the pillars. The knitting pattern is fabricated separately using a portable knitting machine and then manually positioned onto the pillars. The fiber writing apparatus 10 is capable of directly fabricating waving patterns. As shown in FIG. 9, driven by the three-axis motion platform, with a pillar base 16 positioned on a support surface 14, the fiber dispensing head (as shown, a writing head 26; operable as an alternative to the fiber gripper 212 shown in FIGS. 2A and 3) enters the pillar base 16 between the individual pillars 32, navigating through the pillars 32 in the plane along a predefined path, simultaneously tensioning the fiber 28 to tightly bind it around the pillars 32 to avoid moving or floating during the writing process. In some embodiments, a data connector 30 couples a controller 36 to the fiber writing apparatus 10 to control the motion path of the writing head 26 relative to the pillar base 16. A similar controller is used to control the motion of the fiber gripper 212 shown in FIG. 3.

The fixation of the fiber 28 (for use with the writing head 26 or fiber gripper 212) is achieved in two steps, as illustrated in FIGS. 10A-10E. First, the fiber 28 is held in place by a holding device 34, herein illustrated as a binder clip. Then, at the beginning of the writing process, the writing head 26 guides the fiber 28 around the first pillar 32 for three turns to complete the wrapping-based fixation. Similar to the arrangement of the fiber gripper 212 described with respect to FIG. 3, the writing head 26 is movable relative to the pillar base 16 in the x-axis, the y-axis, and the z-axis. A gantry 18 supports a head assembly 24 that includes the writing head 26 at a height (e.g., above) the pillar base 16. The head assembly 24 is driven by a motor 20 to translate the writing head 26 relative to the base 16 to facilitate movement of the fiber 28 relative to the pillars 32. This approach ensures that one end of the fiber 28 is securely anchored, while the fiber 28 remains under tension during the writing process, allowing it to stay tightly bound around the surrounding pillars 32. The inner diameter of the writing head 26 is designed to achieve optimal friction between the fiber 28 and the inner wall, and the tip of the writing head 26 is positioned lower than the top of the pillars 32, thus allowing the fiber 28 to remain under tension and be anchored around the pillars 32. As shown in FIG. 10A, the fiber material is stored on a spool 12, which rotates freely as the fiber 28 is drawn during the writing process. As a result, the fiber 28 is subjected only to a pulling force F1 and a friction force F2 during the fiber writing process, as shown in FIG. 9. Thus, maintaining a balance between the two forces F1, F2 ensures that the fiber 28 remains under tension and securely positioned within the pillar matrix.

FIG. 10C illustrates the pattern formed via the writing head 26 in FIG. 10A. FIG. 10D illustrates a further pattern 128 that modifies a pattern on subsequent layers with a first layer extending around each column of the array of pillars and a second layer extending around each row of the array of pillars. Subsequent layers follow the same pattern. A modified pattern is shown in FIG. 10E in which the first two layers are similar to those in FIG. 10C, but the subsequent third and fourth layers wrap about the opposite ends of the columns and rows.

To ensure complete infiltration of the polymer into the fibers 28, a pre-soaking process is performed where the fibers 28 are immersed in the polymer solution, subjected to vacuum, and held at 60° C. for 30 minutes. Afterward, the fibers 28 are removed and the excess polymer on the surface is gently wiped off (e.g., with a paper towel). The fully soaked fibers 28 are then used for the fiber writing process. Once the desired fiber pattern is fabricated, the sample is transferred to the encapsulation stage, the polymer solution is applied to the fibers 28 (e.g., via a resin tank similar to resin tank 224 shown in FIG. 3) and allowed to rest for 3 minutes before UV curing. This step ensures that no voids remain between the fibers and the surrounding polymer. There is no observable gap at the fiber-matrix interface, demonstrating a fully integrated structure and excellent wetting between the fiber and polymer. By iteratively performing these three steps, it is possible to fabricate complex structures with multiple continuous fiber layers. Experimental results indicate that the matrix between the fiber and the substrate can be fully cured, owing to the fiber's relatively small diameter compared to the UV light exposure area and incident angle, as well as the contribution of light scattering. During post-curing, the sample is illuminated from multiple directions to further ensure complete polymerization.

Although the present subject matter has been described in detail with reference to certain preferred embodiments, variations and modifications exist within the scope of one or more independent aspects of the subject matter as described.

### NOMENCLATURE

CFM continuous fiber manufacturing
FDM fused deposition modelling
DIW direct ink writing
FRC fiber-reinforced composites
PMC polymer matrix composites
PCC polymer ceramic composites
3D three-dimensional
VPP vat photopolymerization
SMA shape memory alloy
SEM scanning electron microscopy
DMD digital micromirror device
CAD computer-aided design
U local diffusion velocity
v first basis vector
x second basis vector
e₁, e₂, e₃ orthogonal unit vectors
C fourth-order elasticity tensor
ε total strain
εₑₗ elastic strain
εᵢₙₑₗ inelastic strains
σₑₓ stress.

1. A method of forming a polymer composite, the method comprising:
forming an array of pillars of a polymer material, each pillar of the array of pillars separated by intermediate spaces;
weaving, waving, and/or knitting a continuous fiber in a controlled pattern within the intermediate spaces between the array of pillars; and
encapsulating the continuous fiber with a subsequent layer of the polymer material.

2. The method of claim 1, wherein each pillar of the array of pillars is formed as a conical frustum, a cylinder, a triangular prism, or a rectangular prism.

3. The method of claim 1, wherein the array of pillars is a first array of pillars, the method further comprising forming a second array of pillars of the polymer material on the subsequent layer of the polymer material.

4. The method of claim 3, wherein the continuous fiber is a first continuous fiber, the method further comprising weaving, waving, and/or knitting a second continuous fiber between the second array of pillars.

5. The method of claim 4, wherein the pattern of the first continuous fiber is distinct from the pattern of the second continuous fiber.

6. The method of claim 1, wherein weaving, waving, and/or knitting the continuous fiber includes moving a gripper into a printing area of the polymer composite to tension the continuous fiber about the pillars of the array of pillars.

7. The method of claim 1, wherein weaving, waving, and/or knitting the continuous fiber includes moving a writing head into a printing area of the polymer composite to tension the continuous fiber about the pillars of the array of pillars.

8. The method of claim 1, wherein prior to weaving, waving, and/or knitting the continuous fiber, the method further comprises pre-soaking the continuous fiber in the polymer material.

9. The method of claim 1, wherein the array of pillars is formed by curing the polymer material into a pillar base having the array of pillars formed thereon, wherein the polymer material is a liquid polymer resin material that is cured into a solid polymer resin material.

10. The method of claim 1, wherein weaving, waving, and/or knitting the continuous fiber in the controlled pattern includes locating a tip of a gripper or writing head into the intermediate space between adjacent pillars of the array of pillars.

11. The method of claim 1, wherein forming the array of pillars and encapsulating the fibers includes curing the polymer material.

12. The method of claim 1, wherein forming the array of pillars includes submersing at least a portion of a build platform into a resin tank, and wherein encapsulating the continuous fiber with the subsequent layer of the polymer material includes submersing at least a portion of the continuous fiber in the resin tank.

13. The method of claim 1, wherein weaving, waving, and/or knitting the continuous fiber includes overlapping multiple layers of the continuous fiber onto the array of pillars.

14. The method of claim 1, wherein prior to weaving, waving, and/or knitting the continuous fiber, the array of pillars is transported from a build platform of a resin tank to a fiber writing apparatus.

15. The method of claim 1, wherein the array of pillars are formed on a build platform of a resin tank, wherein weaving, waving, and/or knitting the continuous fiber includes weaving, waving, and/or knitting the continuous fiber onto the array of pillars positioned on the build platform.

16. An additive manufacturing apparatus comprising:
a build platform positioned relative to a tank containing a polymer material;
a projector configured to selectively solidify the polymer material on the build platform in successive layers to form an array of pillars on the build platform;
a fiber dispensing head configured to grasp and deposit a continuous fiber; and
a controller programmed to move the fiber dispensing head relative to the build platform and deposit the continuous fiber relative to the polymer material in a selected one of a weave, a wave, or a knit.

17. The additive manufacturing apparatus of claim 16, further comprising a multi-axis robotic arm coupled to the fiber dispensing head and configured to move the fiber dispensing head.

18. The additive manufacturing apparatus of claim 16, wherein each pillar of the array of pillars is formed as a conical frustum, a cylinder, a triangular prism, or a rectangular prism.

19. The additive manufacturing apparatus of claim 16, wherein the fiber dispensing head is configured to deposit the continuous fiber about the array of pillars on the build platform.

20. The additive manufacturing apparatus of claim 16, wherein the fiber dispensing head is coupled to a gantry of a fiber writing apparatus separate and distinct from the build platform.
